(19) United States
(12) Patent Application Publication
(10) Pub. No.: US 2025/0356304 A1
(43) Pub. Date: Nov. 20, 2025

(54) PACKAGING MANAGEMENT METHOD AND SYSTEM THEREOF

(71) Applicant: Coupang Corp., Seoul (KR)

(72) Inventors: Rubin ZHAO, Seoul (KR); Yanyang JIANG, Seoul (KR); Hwa Jong PARK, Seoul (KR)

(21) Appl. No.: 19/010,628

(22) Filed: Jan. 6, 2025

(30) Foreign Application Priority Data
May 20, 2024 (KR) 10-2024-0064900

(51) Int. Cl. G06Q 10/0832; B65B 57/10

(52) U.S. Cl. CPC G06Q 10/0832; B65B 57/10

(57) ABSTRACT

A packaging management method is disclosed. The method may be performed by a computing device, and may comprise: receiving an order of a customer including fresh products and non-fresh products; determining a type of fresh product packagable together with the non-fresh product among the fresh products as a target fresh product based on a result of classifying types of the fresh products according to a temperature; and automatically determining whether or not to package the target fresh product and the non-fresh product in the same packaging container.

### CROSS-REFERENCE TO RELATED APPLICATION

This application claims priority from Korean Patent Application No. 10-2024-0064900 filed on May 20, 2024 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a packaging management method and system thereof, and more particularly, to a packaging management method for packaging fresh products and non-fresh products in a single packaging container to reduce a delivery cost, and system thereof.

### 2. Description of the Related Art

Generally, fresh products are shipped from a logistics center handling the fresh products, and non-fresh products are shipped from a logistics center handling the non-fresh products. However, in order to prevent idleness of the logistics center handling the fresh products, some non-fresh products may be shipped together with the fresh products from the logistics center handling the fresh products. Even when the non-fresh products are shipped from the logistics center handling the fresh products, the fresh products and the non-fresh products are separately packaged in many cases. However, most of the delivery cost is calculated based on the number of parcels, and thus, there is a problem that the delivery cost increases when the fresh products and the non-fresh products are packaged as separate parcels even in a situation where the fresh products and the non-fresh products may be received as a single parcel. Accordingly, a packaging management method for reducing a delivery cost of an order that includes both the fresh products and the non-fresh products is required.

### SUMMARY

Aspects of the present disclosure provide a packaging management method that decreases a parcel count and increases a unit per parcel (UPP) by allowing fresh products and non-fresh products to be packaged together under a predetermined condition based on a classification result according to temperatures of the fresh products in an order including both the fresh products and the non-fresh products.

Aspects of the present disclosure also provide a packaging management method that allows a user of a logistics center handling fresh products to efficiently manage the packaging and delivery of an order including both fresh products and non-fresh products.

According to an aspect of the present disclosure, a packaging management method is performed by a computing device, and may comprise: receiving an order of a customer including fresh products and non-fresh products; determining a type of fresh product packagable together with the non-fresh product among the fresh products as a target fresh product based on a result of classifying types of the fresh products according to a temperature; and automatically determining whether or not to package the target fresh product and the non-fresh product in the same packaging container.

In one embodiment, the determining of the type of fresh product packagable together with the non-fresh product among the fresh products as the target fresh product may include determining that the fresh product is not the target fresh product when the type of the fresh product is classified as a frozen product and determining that the fresh product is the target fresh product when the type of the fresh product is classified as either a refrigerated product or a room temperature product.

In one embodiment, the frozen product is a product of which an internal temperature of a packaging container is maintained as a first temperature, the refrigerated product is a product of which an internal temperature of a packaging container is maintained as a second temperature higher than the first temperature, and the room temperature product is a product of which an internal temperature of a packaging container is maintained as a third temperature higher than the second temperature.

In one embodiment, the automatic determining of whether or not to package the target fresh product and the non-fresh product in the same packaging container may include: deciding whether or not the target fresh product and the non-fresh product are packagable together in a first packaging container having a smallest size among packaging containers available in a delivery process of the order; determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision; and determining that the target fresh product and the non-fresh product are not packaged in the same packaging container when the target fresh product and the non-fresh product are not packagable together in a third packaging container having a greatest size among the packaging containers available in the delivery process of the order.

In one embodiment, the automatic determining of whether or not to package the target fresh product and the non-fresh product in the same packaging container includes determining that the target fresh product and the non-fresh product are packaged in the same packaging container when an increase amount in unit per parcel (UPP) in a case where the target fresh product and the non-fresh product are packaged in the same packaging container compared to a case where the target fresh product and the non-fresh product are not packaged in the same packaging container is a preset threshold value or more, and the UPP refers to the number of products per unit package.

In one embodiment, the preset threshold value is determined based on a packaging cost required and a delivery cost saved when the target fresh product and the non-fresh product are packaged in the same packaging container.

In one embodiment, the automatic determining of whether or not to package the target fresh product and the non-fresh product in the same packaging container may include determining that the target fresh product and the non-fresh product are not packaged in the same packaging container when it is determined in advance that the non-fresh product is not packagable together with the fresh product.

In one embodiment, the method may further comprise displaying information related to delivery of the order as a graphical user interface (GUI), wherein the information related to the delivery of the order includes information on which of the fresh products is the target fresh product, information on a product packaged in the same packaging container as the target fresh product, and a parcel count reduced and a value of a UPP increased by packaging the target fresh product and the non-fresh product in the same packaging container, and the UPP refers to the number of products per unit package.

According to another aspect of the present disclosure, a packaging management system may comprise: a processor; and a memory storing instructions, wherein when the instructions are executed by the processor, the instructions cause the processor to perform receiving an order of a customer including fresh products and non-fresh products; determining a type of fresh product packagable together with the non-fresh product among the fresh products as a target fresh product based on a result of classifying types of the fresh products according to a temperature; and automatically determining whether or not to package the target fresh product and the non-fresh product in the same packaging container.

In one embodiment, the determining the type of fresh product packagable together with the non-fresh product among the fresh products as the target fresh product may include determining that the fresh product is not the target fresh product when the type of the fresh product is classified as a frozen product and determining that the fresh product is the target fresh product when the type of the fresh product is classified as either a refrigerated product or a room temperature product.

In one embodiment, the frozen product is a product of which an internal temperature of a packaging container is maintained as a first temperature, the refrigerated product is a product of which an internal temperature of a packaging container is maintained as a second temperature higher than the first temperature, and the room temperature product is a product of which an internal temperature of a packaging container is maintained as a third temperature higher than the second temperature.

In one embodiment, the automatically determining whether or not to package the target fresh product and the non-fresh product in the same packaging container may include: deciding whether or not the target fresh product and the non-fresh product are packagable together in a first packaging container having a smallest size among packaging containers available in a delivery process of the order; determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision; and determining that the target fresh product and the non-fresh product are not packaged in the same packaging container when the target fresh product and the non-fresh product are not packagable together in a third packaging container having a greatest size among the packaging containers available in the delivery process of the order.

In one embodiment, the automatically determining whether or not to package the target fresh product and the non-fresh product in the same packaging container may include determining that the target fresh product and the non-fresh product are packaged in the same packaging container when an increase amount in UPP in a case where the target fresh product and the non-fresh product are packaged in the same packaging container compared to a case where the target fresh product and the non-fresh product are not packaged in the same packaging container is a preset threshold value or more, and the UPP refers to the number of products per unit package.

In one embodiment, the preset threshold value is determined based on a packaging cost required and a delivery cost saved when the target fresh product and the non-fresh product are packaged in the same packaging container.

According to still another aspect of the present disclosure, a computer program may be stored in a computer-readable recording medium coupled to a computing device to execute receiving an order of a customer including fresh products and non-fresh products; determining a type of fresh product packagable together with the non-fresh product among the fresh products as a target fresh product based on a result of classifying types of the fresh products according to a temperature; and automatically determining whether or not to package the target fresh product and the non-fresh product in the same packaging container.

In one embodiment, the determining of the type of fresh product packagable together with the non-fresh product among the fresh products as the target fresh product may include determining that the fresh product is not the target fresh product when the type of the fresh product is classified as a frozen product and determining that the fresh product is the target fresh product when the type of the fresh product is classified as either a refrigerated product or a room temperature product.

In one embodiment, the frozen product is a product of which an internal temperature of a packaging container is maintained as a first temperature, the refrigerated product is a product of which an internal temperature of a packaging container is maintained as a second temperature higher than the first temperature, and the room temperature product is a product of which an internal temperature of a packaging container is maintained as a third temperature higher than the second temperature.

In one embodiment, the automatic determining of whether or not to package the target fresh product and the non-fresh product in the same packaging container may include: deciding whether or not the target fresh product and the non-fresh product are packagable together in a first packaging container having a smallest size among packaging containers available in a delivery process of the order; determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision; and determining that the target fresh product and the non-fresh product are not packaged in the same packaging container when the target fresh product and the non-fresh product are not packagable together in a third packaging container having a greatest size among the packaging containers available in the delivery process of the order.

In one embodiment, the automatic determining of whether or not to package the target fresh product and the non-fresh product in the same packaging container may include determining that the target fresh product and the non-fresh product are packaged in the same packaging container when an increase amount in UPP in a case where the target fresh product and the non-fresh product are packaged in the same packaging container compared to a case where the target fresh product and the non-fresh product are not packaged in the same packaging container is a preset threshold value or more, and the UPP refers to the number of products per unit package.

In one embodiment, the preset threshold value is determined based on a packaging cost required and a delivery cost saved when the target fresh product and the non-fresh product are packaged in the same packaging container.

### BRIEF DESCRIPTION OF THE DRAWINGS

The above and other aspects and features of the present disclosure will become more

apparent by describing in detail exemplary embodiments thereof with reference to the attached drawings, in which:

FIG. 1 is an illustrative block diagram illustrating a configuration of an entire system in which a packaging management system according to an exemplary embodiment of the present disclosure operates;

FIG. 2 is an illustrative diagram illustrating that types of fresh products according to an exemplary embodiment of the present disclosure are classified according to a temperature;

FIG. 3 is an illustrative flowchart illustrating a packaging management method according to an exemplary embodiment of the present disclosure;

FIG. 4 is a flowchart specifically illustrating determining a type of fresh product packagable in the same packaging container together with a non-fresh product as a target fresh product of FIG. 3;

FIGS. 5 to 7 are flowcharts specifically illustrating determining whether or not to package the target fresh product and the non-fresh product in the same packaging container of FIG. 3; and

FIG. 8 is a block diagram illustrating a hardware configuration of a computing device for packaging management according to an exemplary embodiment of the present disclosure.

### DETAILED DESCRIPTION OF THE EMBODIMENTS

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “fresh product” as used herein refers to a product (mainly food) that is sensitive to freshness and thus requires that a packaging container is maintained at a constant temperature in a delivery process, and a fresh product-dedicated packaging container is used. The term “non-fresh product” as used herein refers to the remaining type of product other than the fresh product. The term “parcel” as used herein refers to one or more products contained in a single packaging container, and the term “unit per parcel (UPP)” as used herein refers to the number of products per unit package.

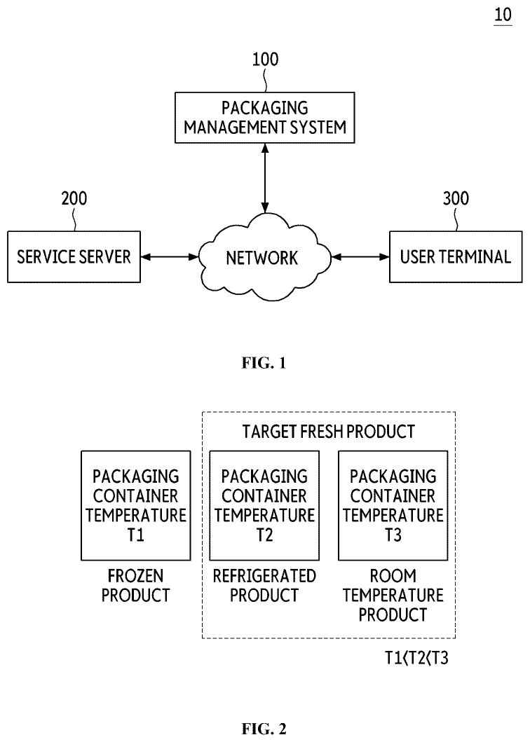

FIG. 1 is an illustrative block diagram illustrating a configuration of an entire system 10 in which a packaging management system 100 according to an exemplary embodiment of the present disclosure operates. Referring to FIG. 1, the entire system 10 may include the packaging management system 100, a service server 200, and a user terminal 300. The entire system 10 according to an exemplary embodiment of the present disclosure may receive an order of a customer according to a shopping service provided by the service server 200 in the packaging management system 100, manage a packaging process for delivery of an order including both fresh products and non-fresh products, and transmit a management result to the user terminal 300 of a logistics center.

The packaging management system 100 may also be configured using one or more physical servers included in a server farm based on cloud technology such as a virtual machine.

More specifically, the packaging management system 100 may receive the order including both the fresh products and the non-fresh products through the service server 200. Here, it is assumed that both the fresh products and the non-fresh products are shipped from a logistics center handling the fresh products (hereinafter referred to as a fresh logistics center). Basically, even though the fresh products and the non-fresh products shipped from the same fresh logistics center, the fresh products are packaged in a fresh product-dedicated packaging container together with fresh products in principle, and the non-fresh products are packaged in a general packaging container (e.g., a vinyl pack) together with non-fresh products in principle.

However, in some cases, the fresh products and the non-fresh products may be packaged in the same packaging container (e.g., the fresh product-dedicated packaging container) in order to reduce a parcel count. This is because a cost of a delivery process is reduced when the parcel count is reduced. Accordingly, the packaging management system 100 may receive the order including both the fresh products and the non-fresh products, and then determine whether or not at least some of the fresh products and at least some of the non-fresh products may be packaged in the same packaging container in the delivery process.

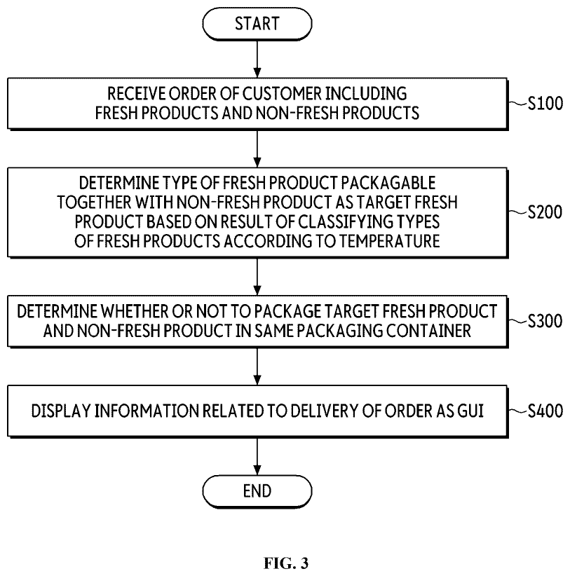

In determining whether or not to package the fresh products and the non-fresh products in the same packaging container, it should first be determined whether or not the fresh product included in the order is a type of fresh product that may be packaged together with the non-fresh products. Determining whether or not the fresh product is the type of fresh product that may be packaged together with the non-fresh products is based on a result of classifying types of fresh products according to a temperature. Hereinafter, classification of types of fresh products according to a temperature will be described with reference to FIG. 2.

FIG. 2 is an illustrative diagram illustrating that types of fresh products according to an exemplary embodiment of the present disclosure are classified according to a temperature. Referring to FIG. 2, the fresh products may be classified as frozen products, refrigerated products, and room temperature products. In a case of the frozen products, an internal temperature of a packaging container may be maintained as T1, in a case of the refrigerated products, an internal temperature of a packaging container may be maintained as T2 higher than T1, and in a case of the room temperature products, an internal temperature of a packaging container may be maintained as T3 higher than T2. For example, T1 may be a temperature below zero, and T2 and T3 may be temperatures above zero.

In a delivery process of the fresh products, the frozen products are packaged together with frozen products, and the refrigerated products and the room temperature products may be packaged together. This is because dry ice for maintaining the internal temperature as the temperature below zero may be included inside the packaging container of the frozen product and there is a risk that quality of the refrigerated products and the room temperature products will deteriorate when the refrigerated products and the room temperature products are packaged together in the packaging container of the frozen product. Meanwhile, the non-fresh products are considered the same as the room temperature products in the fresh logistics center. Accordingly, the frozen product may be classified as a type of fresh product that may not be packaged together with the non-fresh products, and the refrigerated product and the room temperature product may be classified as a type of fresh product that may be packaged together with the non-fresh products. Hereinafter, the refrigerated product and the room temperature product included in the order of the customer will be referred to as a target fresh product.

Referring to FIG. 1 again, when the target fresh product is determined in the order of the customer including both the fresh products and the non-fresh products, it may be determined whether or not to package the target fresh product and the non-fresh product in the same packaging container.

First, the packaging management system 100 may decide whether or not the target fresh product and the non-fresh product may be packaged together in a first packaging container having the smallest size among packaging containers available in the delivery process of the order. When the target fresh product and the non-fresh product may be packaged together in the first packaging container as a result of the decision, the packaging management system 100 may determine that the target fresh product and the non-fresh product are packaged in the same first packaging container.

When the target fresh product and the non-fresh product may not be packaged together in the first packaging container as a result of the decision, the packaging management system 100 may decide whether or not the target fresh product and the non-fresh product may be packaged together in a second packaging container a greater size than the first packaging container by one unit. The packaging management system 100 may repeat the above-described process until a packaging container having a size in which the target fresh product and the non-fresh product may be packaged together is found.

However, when the target fresh product and the non-fresh product may not be packaged together in a third packaging container having the greatest size among the packaging containers available in the delivery process of the order, the packaging management system 100 may determine that the target fresh product and the non-fresh product are not packaged in the same packaging container. In this case, the packaging management system 100 may again determine whether or not to package the target fresh product or the remaining products except for a product having the greatest size among the non-fresh products together.

Meanwhile, even though it is physically possible to package the target fresh product and the non-fresh product in the same packaging container, it should also be decided whether or not an increase amount in unit per parcel (UPP) is significant. The packaging management system 100 may determine that the target fresh product and the non-fresh product are packaged in the same packaging container when the increase amount in UPP in a case where the target fresh product and the non-fresh product are packaged in the same packaging container compared to a case where the target fresh product and the non-fresh product are not packaged in the same packaging container is a preset threshold value or more. For example, the preset threshold value related to the increase amount in UPP may be set based on a packaging cost additionally required when the target fresh product and the non-fresh product are packaged together and a delivery cost saved due to the reduction in the parcel count.

In addition, the packaging management system 100 may decide whether or not the non-fresh product is a type of non-fresh product that may be packaged together with the fresh product. It may be determined in advance by the service server 200 whether or not the non-fresh product is the type of non-fresh product that may be packaged together with the fresh product. A type of non-fresh product that may not be packaged together with the fresh product may be a product that may lower quality (e.g., freshness) of the fresh product when packaged and delivered together with the fresh product, and may be a cleaning product such as a detergent and chlorine bleach. The packaging management system 100 may determine that the type of non-fresh product that may not be packaged together with the fresh product is not packaged together with the target fresh product. In other words, the non-fresh product that may harm user experience of the customer when packaged and delivered together with the fresh product may be determined not to be packaged in the same packaging container as a packaging container of the fresh product. When the non-fresh product is not packaged together with the fresh product but is packaged together with non-fresh products, the non-fresh products may be packaged in a general packaging container.

However, the non-fresh product shipped together with the fresh product from the fresh logistics center is a product that the customer frequently orders together with the fresh product, it will not be frequent for the type of non-fresh product that may not be packaged together with the fresh product to be shipped together with the fresh product.

The packaging management system 100 may display information related to the delivery of the order including both the fresh products and the non-fresh products as a graphical user interface (GUI) on the user terminal 300. For example, the information related to the delivery of the order may include information on which of the fresh products is the target fresh product, information on the non-fresh product packaged together with the target fresh product, and the like. In addition, a parcel count reduced and a value of a UPP increased by packaging the fresh product and the non-fresh product together may also be displayed on the GUI displayed according to the exemplary embodiment of the present disclosure. Consequently, a user of the logistics center may more efficiently manage a delivery process of the order including both the fresh products and the non-fresh products (i.e., a delivery process of the fresh products and the non-fresh products shipped from the fresh logistics center).

The service server 200 may be a computing device/system (platform) that provides the shopping service to the customer. For example, the service server 200 may be a computing device/system that provides an online shopping site to a terminal of the customer. The service server 200 may provide information related to the order including both the fresh products and the non-fresh products among orders received from the customer to the packaging management system 100.

The service server 200 may be implemented as at least one computing device. For example, all functions of the service server 200 may be implemented in one computing device or a first function of the service server 200 may be implemented in a first computing device and a second function of the service server 200 may be implemented in a second computing device. Alternatively, specific functions of the service server 200 may be implemented in a plurality of computing devices. For example, the computing device may include all types of devices including computational means and communication means.

The user terminal 300 may be a computing device used by a user (e.g., a user of the logistics center handling the fresh products) who manages the delivery of the shopping service provided by the service server 200. For example, the user terminal 300 may include a smartphone, a desktop computer, a laptop computer, or the like. For example, when the user terminal 300 is a smartphone, the user may manage the delivery of the shopping service provided by the service server 200 through an application on the smartphone. In this case, information related to the delivery of the order may be displayed as a GUI by the packaging management system 100 on the application. However, the present disclosure is not limited thereto, and the user terminal 300 may be implemented as any device.

Components illustrated in FIG. 1 may communicate with each other through a network. For example, the network may be implemented as all types of wired/wireless networks such as a local area network (LAN), a wide area network (WAN), a mobile radio communication network, and a wireless broadband Internet (Wibro).

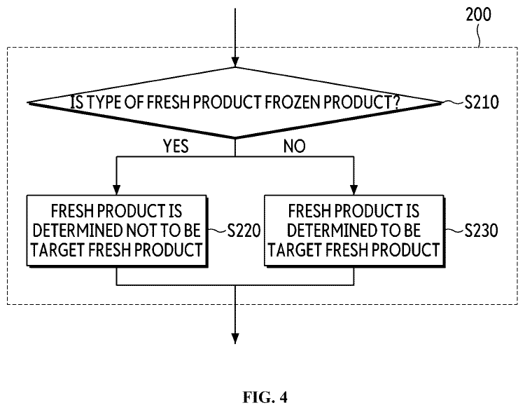

FIG. 3 is an illustrative flowchart illustrating a packaging management method according to an exemplary embodiment of the present disclosure. For reference, FIG. 3 illustrates steps/operations of a packaging management method of a fresh product and a non-fresh product performed in the packaging management system 100 of FIG. 1. Accordingly, in the following descriptions, when a subject of a specific step/operation is omitted, it may be understood that the specific step/operation is performed in the packaging management system 100. Hereinafter, a description will be provided with reference to FIG. 1 along with FIG. 3.

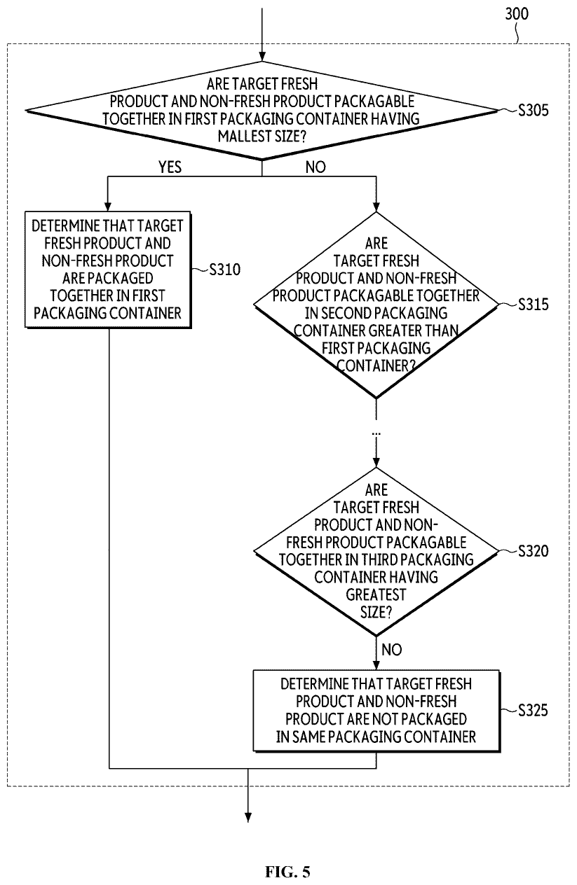

In S100, an order of a customer including both fresh products and non-fresh products may be received. Here, both the fresh products and the non-fresh products may be shipped from the fresh logistics center. In S200, a type of fresh product packagable in the same packaging container together with a non-fresh product may be determined as a target fresh product based on a result of classifying types of the fresh products according to a temperature. Hereinafter, S200 will be described with reference to FIG. 4.

FIG. 4 is a flowchart specifically illustrating determining a type of fresh product packagable in the same packaging container together with a non-fresh product as a target fresh product (S200) of FIG. 3. Referring to FIG. 4, in S210, it may be decided whether or not the type of the fresh product included in the received order is a frozen product. When the type of the fresh product is the frozen product (YES), the fresh product may be determined not to be the target fresh product in S220. On the other hand, when the type of the fresh product is not the frozen product (NO), in other words, when the type of the fresh product is a refrigerated product or a room temperature product, the fresh product may be determined to be the target fresh product in S230.

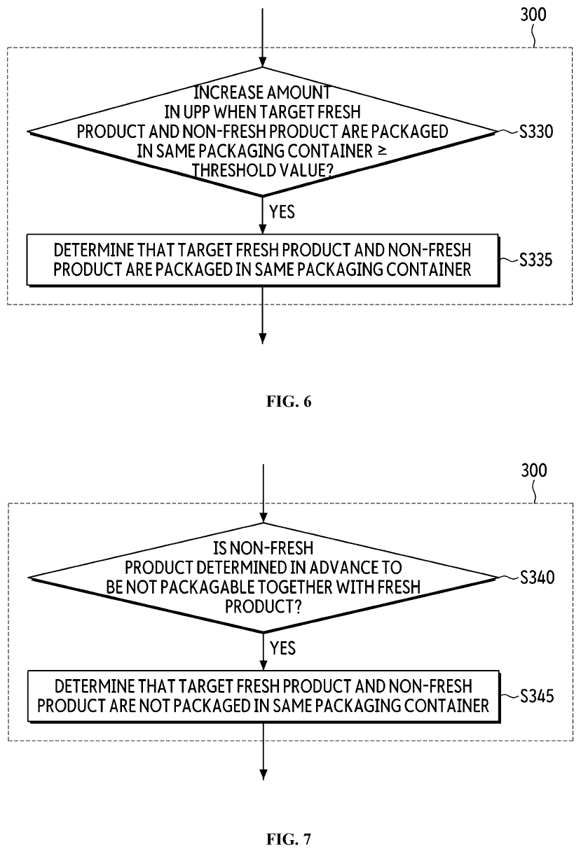

Referring to FIG. 3 again, in S300, it may be determined whether or not to package the target fresh product and the non-fresh product in the same packaging container. Here, the same packaging container may be the fresh product-dedicated packaging container. Hereinafter, exemplary embodiments of S300 will be described with reference to FIGS. 5 to 7.

FIGS. 5 to 7 are flowcharts specifically illustrating determining whether or not to package the target fresh product and the non-fresh product in the same packaging container (S300) of FIG. 3.

First, referring to FIG. 5, in S305, it may be decided whether or not the target fresh product and the non-fresh product may be packaged together in the first packaging container having the smallest size. When the target fresh product and the non-fresh product may be packaged together in the first packaging container (YES), it may be determined that the target fresh product and the non-fresh product are packaged together in the first packaging container in S310. However, when the target fresh product and the non-fresh product may not be packaged together in the first packaging container (NO), it may be decided whether or not the target fresh product and the non-fresh product may be packaged together in the second packaging container greater than the first packaging container by one unit in S315. Although omitted for simplification of illustration, similar to S305 to 315, it may be repeatedly decided whether or not the target fresh product and the non-fresh product may be packaged together for packaging containers of all sizes, and when the target fresh product and the non-fresh product may be packaged together in a corresponding packaging container, it may be determined that the target fresh product and the non-fresh product are packaged together in the corresponding packaging container.

In S320, it may be decided whether or not the target fresh product and the non-fresh product may be packaged together in the third packaging container having the greatest size among the packaging containers. When the target fresh product and the non-fresh product may not be packaged together in the third packaging container (NO), it may be determined that the target fresh product and the non-fresh product are not packaged in the same packaging container in S325. Although omitted for simplification of illustration, when the target fresh product and the non-fresh product may be packaged together in the third packaging container, it may be determined that the target fresh product and the non-fresh product are packaged together in the third packaging container.

Next, referring to FIG. 6, in S330, it may be decided whether or not an increase amount in UPP in a case where the target fresh product and the non-fresh product are packaged in the same packaging container compared to a case where the target fresh product and the non-fresh product are not packaged in the same packaging container is a preset threshold value or more. When the increase amount in UPP is the preset threshold value or more (YES), it may be determined that the target fresh product and the non-fresh product are packaged together in the same packaging container in S335. As described with reference to FIG. 1, the preset threshold value related to the increase amount in UPP may be set based on a packaging cost additionally required when the target fresh product and the non-fresh product are packaged together and a delivery cost saved due to the reduction in the parcel count.

Finally, referring to FIG. 7, in S340, it may be decided whether or not the non-fresh product is a type of product determined in advance to be not packagable together with the fresh product. For example, a non-fresh product that may lower quality of the fresh product when packaged together with the fresh product may be determined in advance to be not packagable together with the fresh product. When the non-fresh product is the type of product determined in advance to be not packagable together with the fresh product (YES), it may be determined that the target fresh product and the non-fresh product are not packaged in the same packaging container.

Referring to FIG. 3 again, in S400, information related to the delivery of the order including both the fresh products and the non-fresh products may be displayed as a graphical user interface (GUI). For example, the information related to the delivery of the order may include information on which of the fresh products is the target fresh product, information on the non-fresh product packaged together with the target fresh product, and the parcel count reduced and the value of the UPP increased by packaging the fresh product and the non-fresh product together. For example, the GUI may be displayed on an application executed on the user terminal 300.

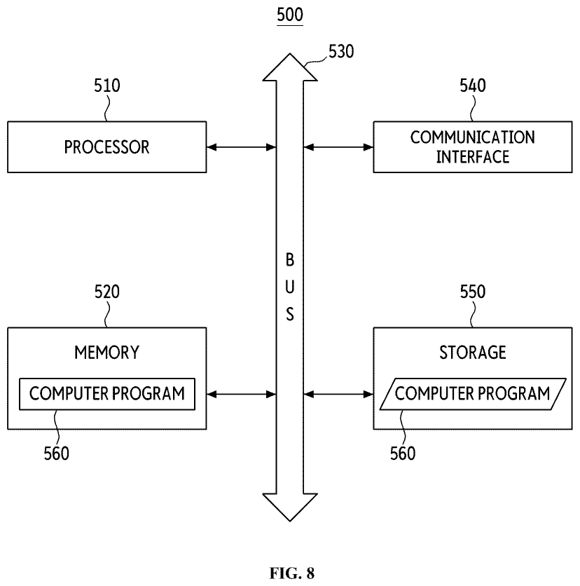

FIG. 8 is a block diagram illustrating a hardware configuration of a computing device 500 for packaging management according to an exemplary embodiment of the present disclosure.

Referring to FIG. 8, the computing device 500 may include one or more processors 510, a bus 530, a communication interface 540, a memory 520 loading a computer program 560 executed by the processor 510, and a storage 550 storing the computer program 560. However, only components related to an exemplary embodiment of the present disclosure have been illustrated in FIG. 8. Accordingly, one of ordinary skill in the art to which the present disclosure pertains may understand that the computing device 500 may further include other general-purpose components in addition to the components illustrated in FIG. 8. That is, the computing device 500 may further include various components in addition to the components illustrated in FIG. 8. In addition, in some cases, the computing device 500 may be configured in a form in which some of the components illustrated in FIG. 8 are omitted. Hereinafter, respective components of the computing device 500 will be described.

The processor 510 may control overall operations of the respective components of the computing device 500. The processor 510 may be configured to include at least one of a central processing unit (CPU), a micro processor unit (MPU), a micro controller unit (MCU), a graphic processing unit (GPU), or any type of processor well known in the art to which the present disclosure pertains. In addition, the processor 510 may perform an arithmetic operation on at least one application or program for executing operations/methods according to exemplary embodiments of the present disclosure. The computing device 500 may include one or more processors.

Next, the memory 520 may store various data, commands, and/or information. The memory 520 may load the computer program 560 from the storage 550 in order to execute the operations/methods according to exemplary embodiments of the present disclosure. The memory 520 may be implemented as a volatile memory such as a random access memory (RAM), but the present disclosure is not limited thereto.

Next, the bus 530 may provide a communication function between the components of the computing device 500. The bus 530 may be implemented as various types of buses such as an address bus, a data bus, and a control bus.

Next, the communication interface 540 may support wired/wireless Internet communication of the computing device 500. In addition, the communication interface 540 may support various communication methods other than the Internet communication. To this end, the communication interface 540 may be configured to include a communication module well known in the art to which the present disclosure pertains.

Next, the storage 550 may non-temporarily store one or more computer programs 560. The storage 550 may be configured to include a nonvolatile memory such as a read only memory (ROM), an erasable programmable (EPROM), an electrically erasable programmable ROM (EEPROM), or a flash memory, a hard disk, a removable disk, or any type of computer-readable recording medium well known in the art to which the present disclosure pertains.

Next, the computer program 560 may include one or more instructions for causing the processor 520 to perform operations/methods according to various exemplary embodiments of the present disclosure when they are loaded into the memory 510. That is, the processor 510 may perform the operations/methods according to various exemplary embodiments of the present disclosure by executing the loaded one or more instructions.

For example, the computer program 560 may include instructions for receiving an order of a customer including fresh products and non-fresh products, determining a type of fresh product packagable together with the non-fresh product among the fresh products as a target fresh product based on a result of classifying types of the fresh products according to a temperature, and determining whether or not to package the target fresh product and the non-fresh product in the same packaging container.

In addition, the computer program 560 may include instructions for determining that the fresh product is not the target fresh product when the type of the fresh product is classified as a frozen product and determining that the fresh product is the target fresh product when the type of the fresh product is classified as either a refrigerated product or a room temperature product.

Further, the computer program 560 may include instructions for deciding whether or not the target fresh product and the non-fresh product are packagable together in a first packaging container having the smallest size among packaging containers available in a delivery process of the order, determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision, and determining that the target fresh product and the non-fresh product are not packaged in the same packaging container when the target fresh product and the non-fresh product are not packagable together in a third packaging container having the greatest size among the packaging containers available in the delivery process of the order.

Furthermore, the computer program 560 may include instructions for packaging the target fresh product and the non-fresh product in the same packaging container when an increase amount in UPP in a case where the target fresh product and the non-fresh product are packaged in the same packaging container compared to a case where the target fresh product and the non-fresh product are not packaged in the same packaging container is a preset threshold value or more.

According to an exemplary embodiment of the present disclosure, by packaging the non-fresh product shipped from the fresh logistics center together with the fresh product in order to prevent idleness of the fresh logistics center, the parcel count may be reduced and the UPP may be increased, and accordingly, the delivery cost may be reduced. In addition, by preventing the frozen product from being packaged together with the non-fresh product and allowing only the refrigerated product or the room temperature product from being packaged together with the non-fresh product, it is possible to prevent a phenomenon in which the quality of the refrigerated product and the room temperature product is deteriorated when the fresh product and the non-fresh product are packaged in the same packaging container.

Various embodiments and the effects thereof according to the present disclosure have been mentioned with reference to FIGS. 1 through 8. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A packaging management method performed by a computing device, comprising:
receiving an order of a customer including fresh products and non-fresh products;
determining a type of fresh product packagable together with the non-fresh product among the fresh products as a target fresh product based on a result of classifying types of the fresh products according to a temperature; and
automatically determining whether or not to package the target fresh product and the non-fresh product in the same packaging container.

2. The packaging management method of claim 1, wherein the determining of the type of fresh product packagable together with the non-fresh product among the fresh products as the target fresh product includes determining that the fresh product is not the target fresh product when the type of the fresh product is classified as a frozen product and determining that the fresh product is the target fresh product when the type of the fresh product is classified as either a refrigerated product or a room temperature product.

3. The packaging management method of claim 2, wherein the frozen product is a product of which an internal temperature of a packaging container is maintained as a first temperature,
the refrigerated product is a product of which an internal temperature of a packaging container is maintained as a second temperature higher than the first temperature, and
the room temperature product is a product of which an internal temperature of a packaging container is maintained as a third temperature higher than the second temperature.

4. The packaging management method of claim 1, wherein the automatic determining of whether or not to package the target fresh product and the non-fresh product in the same packaging container includes:
deciding whether or not the target fresh product and the non-fresh product are packagable together in a first packaging container having a smallest size among packaging containers available in a delivery process of the order;
determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision; and
determining that the target fresh product and the non-fresh product are not packaged in the same packaging container when the target fresh product and the non-fresh product are not packagable together in a third packaging container having a greatest size among the packaging containers available in the delivery process of the order.

5. The packaging management method of claim 1, wherein the automatic determining of whether or not to package the target fresh product and the non-fresh product in the same packaging container includes determining that the target fresh product and the non-fresh product are packaged in the same packaging container when an increase amount in unit per parcel (UPP) in a case where the target fresh product and the non-fresh product are packaged in the same packaging container compared to a case where the target fresh product and the non-fresh product are not packaged in the same packaging container is a preset threshold value or more, and
the UPP refers to the number of products per unit package.

6. The packaging management method of claim 5, wherein the preset threshold value is determined based on a packaging cost required and a delivery cost saved when the target fresh product and the non-fresh product are packaged in the same packaging container.

7. The packaging management method of claim 1, wherein the automatic determining of whether or not to package the target fresh product and the non-fresh product in the same packaging container includes determining that the target fresh product and the non-fresh product are not packaged in the same packaging container when it is determined in advance that the non-fresh product is not packagable together with the fresh product.

8. The packaging management method of claim 1, further comprising displaying information related to delivery of the order as a graphical user interface (GUI),
wherein the information related to the delivery of the order includes information on which of the fresh products is the target fresh product, information on a product packaged in the same packaging container as the target fresh product, and a parcel count reduced and a value of a UPP increased by packaging the target fresh product and the non-fresh product in
the same packaging container, and the UPP refers to the number of products per unit package.

9. A packaging management system comprising:
a processor; and
a memory storing instructions,
wherein when the instructions are executed by the processor, the instructions cause the processor to perform
receiving an order of a customer including fresh products and non-fresh products;
determining a type of fresh product packagable together with the non-fresh product among the fresh products as a target fresh product based on a result of classifying types of the fresh products according to a temperature; and
automatically determining whether or not to package the target fresh product and the non-fresh product in the same packaging container.

10. The packaging management system of claim 9, wherein the determining the type of fresh product packagable together with the non-fresh product among the fresh products as the target fresh product includes determining that the fresh product is not the target fresh product when the type of the fresh product is classified as a frozen product and determining that the fresh product is the target fresh product when the type of the fresh product is classified as either a refrigerated product or a room temperature product.

11. The packaging management system of claim 10, wherein the frozen product is a product of which an internal temperature of a packaging container is maintained as a first temperature,
the refrigerated product is a product of which an internal temperature of a packaging container is maintained as a second temperature higher than the first temperature, and
the room temperature product is a product of which an internal temperature of a packaging container is maintained as a third temperature higher than the second temperature.

12. The packaging management system of claim 9, wherein the automatically determining whether or not to package the target fresh product and the non-fresh product in the same packaging container includes:
deciding whether or not the target fresh product and the non-fresh product are packagable together in a first packaging container having a smallest size among packaging containers available in a delivery process of the order;
determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision; and
determining that the target fresh product and the non-fresh product are not packaged in the same packaging container when the target fresh product and the non-fresh product are not packagable together in a third packaging container having a greatest size among the packaging containers available in the delivery process of the order.

13. The packaging management system of claim 9, wherein the automatically determining whether or not to package the target fresh product and the non-fresh product in the same packaging container includes determining that the target fresh product and the non-fresh product are packaged in the same packaging container when an increase amount in UPP in a case where the target fresh product and the non-fresh product are packaged in the same packaging container compared to a case where the target fresh product and the non-fresh product are not packaged in the same packaging container is a preset threshold value or more, and
the UPP refers to the number of products per unit package.

14. The packaging management system of claim 13, wherein the preset threshold value is determined based on a packaging cost required and a delivery cost saved when the target fresh product and the non-fresh product are packaged in the same packaging container.

15. A computer program stored in a computer-readable recording medium coupled to a computing device to execute
receiving an order of a customer including fresh products and non-fresh products;
determining a type of fresh product packagable together with the non-fresh product among the fresh products as a target fresh product based on a result of classifying types of the fresh products according to a temperature; and
automatically determining whether or not to package the target fresh product and the non-fresh product in the same packaging container.

16. The computer program of claim 15, wherein the determining of the type of fresh product packagable together with the non-fresh product among the fresh products as the target fresh product includes determining that the fresh product is not the target fresh product when the type of the fresh product is classified as a frozen product and determining that the fresh product is the target fresh product when the type of the fresh product is classified as either a refrigerated product or a room temperature product.

17. The computer program of claim 16, wherein the frozen product is a product of which an internal temperature of a packaging container is maintained as a first temperature,
the refrigerated product is a product of which an internal temperature of a packaging container is maintained as a second temperature higher than the first temperature, and
the room temperature product is a product of which an internal temperature of a packaging container is maintained as a third temperature higher than the second temperature.

18. The computer program of claim 15, wherein the automatic determining of whether or not to package the target fresh product and the non-fresh product in the same packaging container includes:
deciding whether or not the target fresh product and the non-fresh product are packagable together in a first packaging container having a smallest size among packaging containers available in a delivery process of the order;
determining that the target fresh product and the non-fresh product are packaged in the same first packaging container when the target fresh product and the non-fresh product are packagable together in the first packaging container as a result of the decision and deciding whether or not the target fresh product and the non-fresh product are packagable together in a second packaging container having a greater size than the first packaging container by one unit when the target fresh product and the non-fresh product are not packagable together in the first packaging container as a result of the decision; and
determining that the target fresh product and the non-fresh product are not packaged in the same packaging container when the target fresh product and the non-fresh product are not packagable together in a third packaging container having a greatest size among the packaging containers available in the delivery process of the order.

19. The computer program of claim 15, wherein the automatic determining of whether or not to package the target fresh product and the non-fresh product in the same packaging container includes
determining that the target fresh product and the non-fresh product are packaged in the same packaging container when an increase amount in UPP in a case where the target fresh product and the non-fresh product are packaged in the same packaging container compared to a case where the target fresh product and the non-fresh product are not packaged in the same packaging container is a preset threshold value or more, and
the UPP refers to the number of products per unit package.

20. The computer program of claim 19, wherein the preset threshold value is determined based on a packaging cost required and a delivery cost saved when the target fresh product and the non-fresh product are packaged in the same packaging container.
